(19) United States
(12) Patent Application Publication
(10) Pub. No.: US 2026/0211595 A1
(43) Pub. Date: Jul. 23, 2026

(54) NON-TRANSITORY COMPUTER READABLE STORAGE MEDIUM AND INFORMATION PROCESSING DEVICE

(71) Applicant: BROTHER KOGYO KABUSHIKI KAISHA, Nagoya (JP)

(72) Inventor: Masatoshi Kadota, Takahama (JP)

(21) Appl. No.: 19/570,618

(22) Filed: Mar. 18, 2026

Related U.S. Application Data
(63) Continuation of application No. PCT/JP2025/004103, filed on Feb. 7, 2025.

(30) Foreign Application Priority Data
Mar. 25, 2024 (JP) 2024-048098

(51) Int. Cl. G06F 3/12

(52) U.S. Cl. CPC G06F 3/1228; G06F 3/1203; G06F 3/1232

(57) ABSTRACT

A non-transitory computer readable storage medium storing an information processing program executable by a processor of an information processing device. The information processing device is loaded with an operating system having printing software for executing printing. The information processing program is configured to be registered in the printing software as a virtual printing device. The information processing program is configured to execute print control using a printing device configured to communicate with the information processing device. The printing device is configured to execute printing on a printing sheet stored in a paper tray.

### REFERENCE TO RELATED APPLICATIONS

This is a continuation application of International Application No. PCT/JP2025/004103 filed on February 7, 2025, which claims priority from Japanese Patent Application No. 2024-048098 filed on March 25, 2024. The entire contents of the aforementioned applications are incorporated herein by reference.

### BACKGROUND ART

An operating system (OS) having a so-called driverless printing function for executing printing according to a predetermined printing standard without using a printer driver provided by a printer vendor is now widely used. In this case, printing can be executed without installing a printer driver.

As a technique using such a driverless OS printing function for supporting a printing device that does not support driverless printing or for extending the function of normal driverless printing, for example, related art describes a technique in which a virtual printer that receives a print job from an OS and transmits the received print job to a printing device is created in an information processing device.

In the related art, the capability information transmitted from the virtual printer to the driverless printing function of the OS includes all paper sizes available in the connected printing device. Thus, all the paper sizes are displayed to be selectable by a user, on a print setting screen based on the driverless printing function of the OS.

However, the paper sizes displayed as described above may include a paper size that is not actually stored in a paper tray of the printing device. In practice, in a case where a sheet of a size not stored in the paper tray of the printing device is selected and printing is executed, the user may be forced to replace the sheet or to make extra settings.

An object of the present disclosure is to provide an information processing program and an information processing device capable of preventing an erroneous setting of a paper size based on capability information transmitted from a virtual printer to an OS.

### SUMMARY

A non-transitory computer readable storage medium storing an information processing program executable by a processor of an information processing device, the information processing program being configured to execute print control using a printing device configured to communicate with the information processing device, the printing device being configured to execute printing on a printing sheet stored in a paper tray, the information processing device being loaded with an operating system having printing software for executing printing in response to an instruction from an application, and the information processing program being configured to be registered in the printing software as a virtual printing device, in which the information processing program is configured to, when executed by the processor, cause, on a condition that the information processing program is registered in the printing software as the virtual printing device, a controller of the information processing device to execute: an environment information acquisition process of acquiring sheet feed environment information related to the paper tray provided in the printing device and to the printing sheet stored in the paper tray; a capability information generation process of generating valid capability information according to the sheet feed environment information acquired in the environment information acquisition process; a capability information output process of outputting, to the printing software, the valid capability information generated in the capability information generation process; a print data acquisition process of acquiring, from the printing software, first print data corresponding to the valid capability information output in the capability information output process; and a print data transmission process of transmitting, to the printing device, second print data based on the first print data acquired in the print data acquisition process.

### BRIEF DESCRIPTION OF DRAWINGS

FIG. 1 is a block diagram illustrating an example of a system configuration of a printing system and a functional configuration of a terminal device according to an embodiment of the present disclosure.

FIG. 2A is a diagram illustrating a comparative example in which an attribute includes all paper sizes available in a printer.

FIG. 2B is a diagram illustrating a specific example of a paper selection menu and a tray selection menu displayed on a print setting screen by an application in the comparative example in which an attribute includes all paper sizes available in a printer.

FIG. 3A is a diagram for illustrating a paper selection menu and a tray selection menu displayed on a print setting screen by an application in the embodiment.

FIG. 3B is a diagram illustrating a specific example of a paper selection menu and the tray selection menu displayed on the print setting screen by the application in the embodiment.

FIG. 4A is a diagram for illustrating a paper selection menu and a tray selection menu displayed on a print setting screen by an application in the embodiment.

FIG. 4B is a diagram illustrating a specific example of a paper selection menu and the tray selection menu displayed on the print setting screen by the application in the embodiment.

FIG. 5A is a diagram for illustrating a paper selection menu and a tray selection menu displayed on a print setting screen by an application in the embodiment.

FIG. 5B is a diagram illustrating a specific example of the paper selection menu and the tray selection menu displayed on the print setting screen by the application in the embodiment.

FIG. 6A is a diagram for illustrating a paper selection menu and a tray selection menu displayed on a print setting screen by an application in the embodiment.

FIG. 6B is a diagram illustrating a specific example of the paper selection menu and the tray selection menu displayed on the print setting screen by the application in the embodiment.

FIG. 7 is a flowchart illustrating an example of a control procedure executed by a printer application to realize display of the paper selection menu and the tray selection menu according to the embodiment.

FIG. 8 is a flowchart illustrating an example of a control procedure executed in a tray-related process in step S100.

FIG. 9 is a flowchart illustrating an example of a control procedure executed in a tray checking process in step S200.

FIG. 10 is a flowchart illustrating an example of a control procedure executed in a tray checking process in a modification in which a tray selection menu displays that a paper tray is empty.

FIG. 11 is a block diagram illustrating an example of a hardware configuration of the terminal device and a printer.

### DESCRIPTION

### Embodiment

An embodiment of the present disclosure will be described with reference to the drawings.

### Outline of Printing System

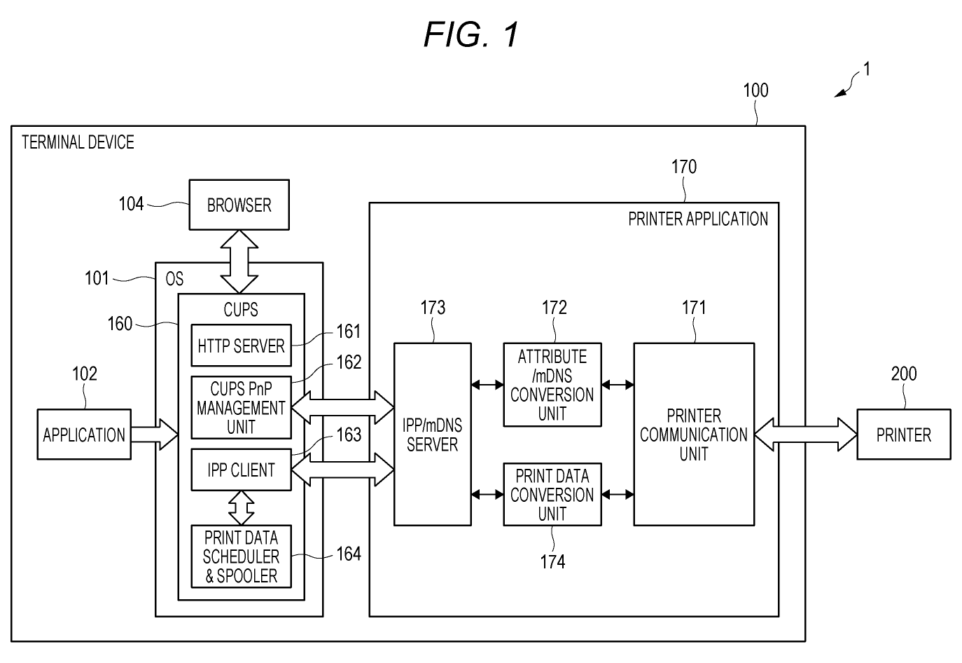

FIG. 1 illustrates an example of a system configuration of a printing system 1 according to the present embodiment. In FIG. 1, a printing system 1 includes a terminal device 100 and a printer 200. The terminal device 100 and the printer 200 are communicably connected via, for example, the Internet, a wired LAN, a wireless LAN, or the like. The terminal device 100 is an example of an information processing device, and the printer 200 is an example of a printing device.

### Functional Configuration of Terminal Device

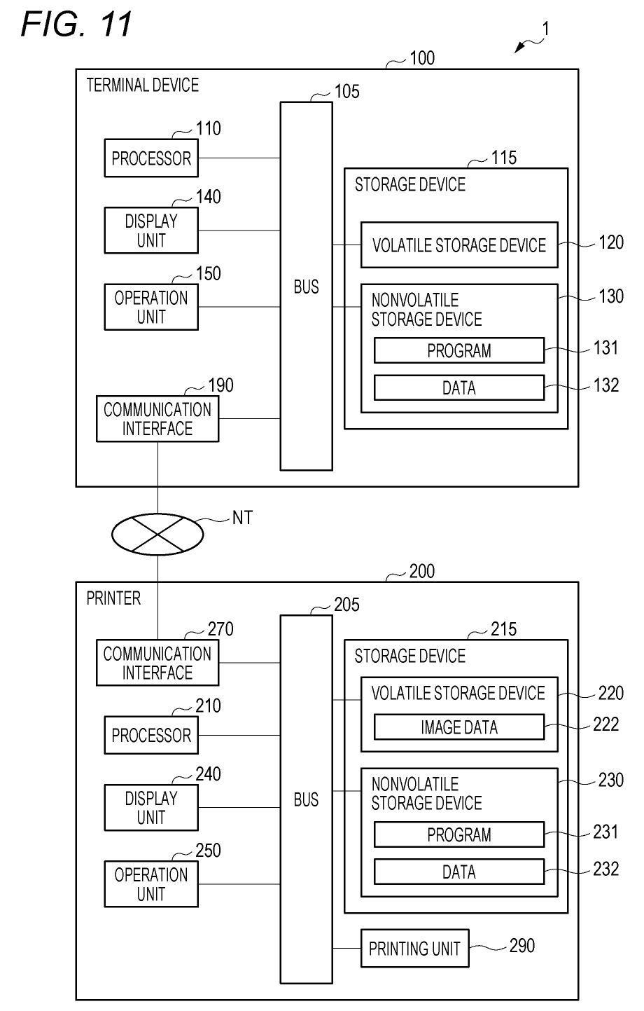

The terminal device 100 is configured to transmit print data to the printer 200 to execute printing. The terminal device 100 is, for example, a desktop PC, a notebook PC, or a tablet computer. Alternatively, the terminal device 100 may be a mobile terminal such as a smartphone. Although details will be described later, the terminal device 100 includes a processor 110 and a storage device 115 that stores various printing processing programs (see FIG. 11 to be described later). As the processor 110 executes various printing processing programs, the terminal device 100 has the functional configuration illustrated in FIG. 1. In the following description, the description that a program performs * * * means that a process of * * * is executed by the processor 110 executing the program.

As illustrated in FIG. 1, the terminal device 100 includes an operating system (OS) 101, an application 102 corresponding to a printing function of the OS, a printer application 170, and a browser 104. The OS 101 has a so-called driverless printing function of executing printing according to a predetermined printing standard without using a printer driver provided by a printer vendor.

The OS 101 includes, for example, a common unix printing system (CUPS) 160, which is a modularized printing system for the OS. The OS 101 is an example of an operating system, and the CUPS 160 is an example of a printing software. The printing software may be incorporated in the OS 101 as a standard.

### CUPS

The CUPS 160 includes an HTTP server 161, a CUPS PnP management unit 162, an IPP client 163, and a print data scheduler & spooler 164.

The HTTP server 161 is server software that operates on the CUPS 160. The HTTP server 161 acquires information and functions using a hypertext transfer protocol (HTTP) via the browser 104, or provides information and functions thereto.

The CUPS PnP management unit 162 has a plug and play (PnP) function of registering, in the CUPS 160, a printer (including a virtual printing device) detected using a protocol such as multicast Domain Name System/Service Discovery (mDNS/SD) to create a print queue.

The setting of the CUPS PnP management unit 162 is changed such that a search address for PnP is limited to an internal network (normally, IP address 127.0.0.1) of the terminal device 100 using a script executed when the printer application 170 is installed. Therefore, the CUPS 160 cannot directly recognize the printer 200, and recognizes the printer application 170 as a printer. The printer application 170 is not a real printer but a so-called virtual printer that acts as a printer for the CUPS 160. The printer application 170 is configured to mediate between the CUPS 160 and the printer 200 to realize printing using the CUPS 160 and the printer 200. The printer application 170 is an example of a virtual printing device.

The IPP client 163 is configured to transmit and receive print data or an attribute to and from an IPP/mDNS server 173 to be described below, using the IPP protocol.

The print data scheduler & spooler 164 is configured to manage a print job transmitted from the application 102 or the like, and the print data scheduler & spooler 164 is configured to temporarily block and sequentially process a plurality of print jobs generated at the same time to manage the print jobs to be transferred to the IPP client 163.

### Printer Application

The printer application 170 can be registered in the CUPS 160 as a virtual printer corresponding to the connected printer 200. The CUPS 160 is configured to handle the printer application 170 as a virtual printer and execute various processes related to printing. The various processes include, for example, a capability information acquisition process and a print data output process. The printer application 170 includes a printer communication unit 171, an attribute/mDNS conversion unit 172, the IPP/mDNS server 173, and a print data conversion unit 174. The printer application 170 is an example of an information processing program.

The printer communication unit 171 is configured to communicate with the printer 200. The printer communication unit 171 is configured to receive capability information from the printer 200 and transmit print data to the printer 200. Communication between the printer communication unit 171 and the printer 200 is performed via a network, a USB, or the like. In the case of a network, protocols such as IPP and LPD are used. As the capability information, an IPP attribute is used in the case of using an IPP protocol, and PJL information is used in the case of using another interface or protocol such as USB.

The attribute/mDNS conversion unit 172 is configured to acquire, via the printer communication unit 171, capability information representing the capability of the printer 200. In the present exemplary embodiment, the attribute/mDNS conversion unit 172 is configured to acquire, via the printer communication unit 171, information related to a paper tray provided in the printer 200 and information related to a printing sheet stored in the paper tray. The attribute/mDNS conversion unit 172 is configured to generate an IPP attribute related to the paper tray and the printing sheet of the printer 200, according to the acquired information. The attribute/mDNS conversion unit 172 is configured to convert the attribute acquired or generated from the printer 200 into an IPP attribute according to a printing function that can be handled by the CUPS 160.

The attribute/mDNS conversion unit 172 has a function of a multicast domain name system (mDNS). The mDNS is configured to simultaneously distribute a DNS inquiry in a local network by Internet Protocol (IP) multicast, and simultaneously make an inquiry to all devices in the same network. A device that has received the inquiry is configured to transmit its own IP address as a response.

In response to the capability information acquisition process of the CUPS 160, the IPP/mDNS server 173 is configured to output, to the CUPS 160, the attribute converted by the attribute/mDNS conversion unit 172. The CUPS 160 is configured to output print data corresponding to the attribute converted by the IPP client 163. In response to the print data output process by the CUPS 160, the IPP/mDNS server 173 is configured to acquire print data output from the CUPS 160 and corresponding to the converted attribute, and output the print data to the print data conversion unit 174. The IPP/mDNS server 173 has a function of mDNS similarly to the attribute/mDNS conversion unit 172.

The print data conversion unit 174 is configured to acquire print data from the CUPS 160 via the IPP/mDNS server 173. The acquisition of the print data by the print data conversion unit 174 is an example of a print data acquisition process, and the acquired print data is an example of first print data. The print data conversion unit 174 is configured to convert the print data acquired from the CUPS 160 into print data according to a printing function of the printer 200. The print data conversion unit 174 is configured to output the converted print data to the printer communication unit 171.

The printer communication unit 171 is configured to transmit, to the printer 200, the print data output from the print data conversion unit 174. The transmission of the print data by the printer communication unit 171 is an example of a print data transmission process, and the transmitted print data is an example of second print data based on the first print data. The second print data may be the first print data as it is.

### Printer

Based on the print job transmitted from the printer communication unit 171 of the terminal device 100, the printer 200 is configured to execute printing on a printing sheet stored in a paper tray. The number of paper trays included in the printer 200 may be one or more.

The printer 200 is configured to transmit sheet empty information and sheet information of each tray using PJL. Since this configuration is known, detailed description thereof will be omitted.

### Features of Present Embodiment

The user edits the print data using the application 102, selects a size of the printing sheet, and issues a print execution instruction. At this time, the printer application 170 is configured to inquiry of the printer 200 about information related to the size of the printing sheet, generate an attribute related to the printing sheet based on the acquired information, and transmit the attribute to the CUPS 160. The CUPS 160 is configured to provide the application 102 with the received attribute related to the printing sheet. Accordingly, selectable sizes of the printing sheets are displayed on a print setting screen by the application 102.

In a case where the attribute transmitted from the printer application 170 to the CUPS 160 includes all paper sizes including paper sizes potentially usable in the printer 200, all the paper sizes are displayed on the print setting screen of the application 102 so as to be selectable. In this case, the paper sizes displayed on the print setting screen may include a paper size that is not actually set in the paper tray of the printer 200. In practice, in a case where printing is executed by selecting a printing sheet of a size that is not set in the paper tray of the printer 200, the user is unintentionally forced to replace the sheet or to make extra settings.

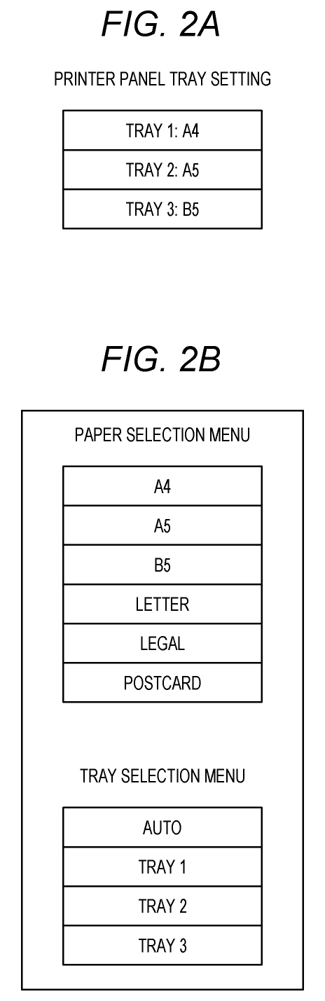

FIGS. 2A and 2B illustrate a specific example of a paper selection menu and a tray selection menu displayed on the print setting screen by the application 102 in a comparative example in which the attribute includes all paper sizes available in the printer 200 as described above. In the example illustrated in FIG. 2A, the printer 200 includes three paper trays including a tray 1, a tray 2, and a tray 3. A size of a printing sheet stored in each tray is set to A4 for the tray 1, A5 for the tray 2, and B5 for the tray 3 via an operation unit such as a printer panel. In the printer 200, in addition to A4, A5, and B5, for example, paper sizes of Letter, Legal, or Postcard can be used. Therefore, in the comparative example, as illustrated in FIG. 2B, all paper sizes of A4, A5, B5, Letter, Legal, and Postcard are displayed in the paper selection menu of the application 102. In the tray selection menu, "tray 1", "tray 2", and "tray 3", which are all trays included in the printer 200, and "Auto", which is an automatic selection setting for automatically selecting a paper tray according to the selected paper size, are displayed.

In the case of this comparative example, the user may erroneously set one of the paper sizes Letter, Legal, and Postcard that are not actually set in the paper tray of the printer 200. In this case, printing not intended by the user is executed, a printing error occurs, or the like, and the user is forced to replace the sheet or to make extra settings.

Therefore, in the present embodiment, the printer application 170 is configured to acquire information related to the paper tray provided in the printer 200 and the size of the printing sheet stored in the paper tray, generate an attribute based on the acquired information, and transmit the attribute to the CUPS 160. Accordingly, the generated attribute can be matched with the size of the printing sheet actually stored in the paper tray provided in the printer 200. As a result, it is possible to prevent a paper size selected and set by the user from being erroneously set to a size that does not match the paper size actually printable by the printer 200.

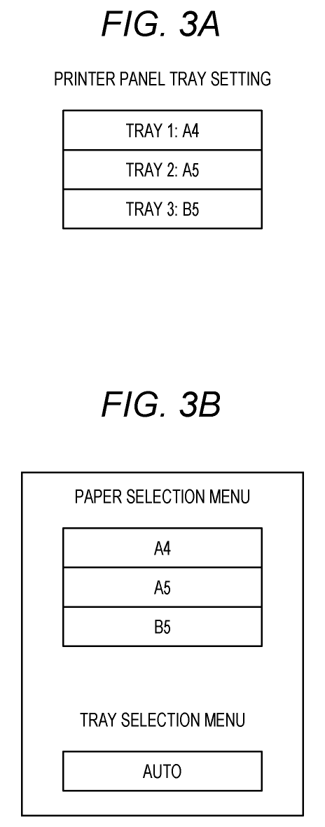

FIGS. 3A to 6B illustrate specific examples of a paper selection menu and a tray selection menu displayed on the print setting screen by the application 102 in the present embodiment. In the example illustrated in FIG. 3A, the printer 200 includes three paper trays including the tray 1, the tray 2, and the tray 3, and a size of a printing sheet stored in each tray is set to A4 for the tray 1, A5 for the tray 2, and B5 for the tray 3. In this case, as illustrated in FIG. 3B, paper sizes of A4, A5, and B5 are displayed in the paper selection menu of the application 102, and "Auto" is displayed in the tray selection menu. Accordingly, the user can set only the paper size actually stored in the paper tray provided in the printer 200, so that an erroneous setting of the paper size can be prevented. As the paper tray is set to "Auto", a paper tray suitable for the paper size selected by the user is automatically selected. In this example, the tray 1 is automatically selected when A4 is selected as the paper size, the tray 2 is automatically selected when A5 is selected, and the tray 3 is automatically selected when B5 is selected.

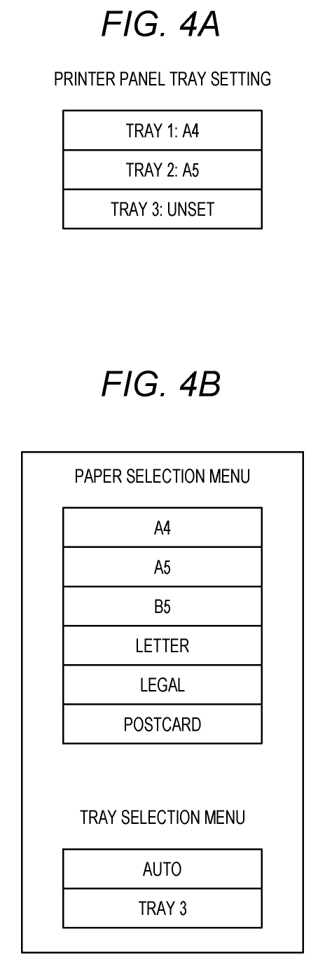

In the example illustrated in FIG. 4A, the printer 200 includes three paper trays including the tray 1, the tray 2, and the tray 3, and a size of a printing sheet stored in each tray is set to A4 for the tray 1, A5 for the tray 2, and not set for the tray 3. In this case, there is a possibility that any of the printing sheets having a size that can be stored in the tray 3 is set in the tray 3. In this example, the tray 3 is configured to store all paper sizes of A4, A5, B5, Letter, Legal, and Postcard. Therefore, as illustrated in FIG. 4B, the paper selection menu of the application 102 displays all paper sizes of B5, Letter, Legal, and Postcard in addition to A4 and A5 set for the tray 1 and the tray 2. Further, in the tray selection menu, in addition to "Auto", an unset tray 3 is displayed. Accordingly, in a case where the user executes printing on a sheet of A4 or A5, the user can select the corresponding paper size in the paper selection menu and select "Auto" in the tray selection menu to automatically select a paper tray suitable for the paper size. In a case where the user executes printing on a printing sheet of a size other than A4 and A5, the user selects the corresponding paper size in the paper selection menu and selects "Auto" or "tray 3" in the tray selection menu, thereby preventing "tray 1" and "tray 2" in which A4 and A5 are set from being selected. In this case, a printing sheet of a size to be printed by the user is set or needs to be set in the tray 3.

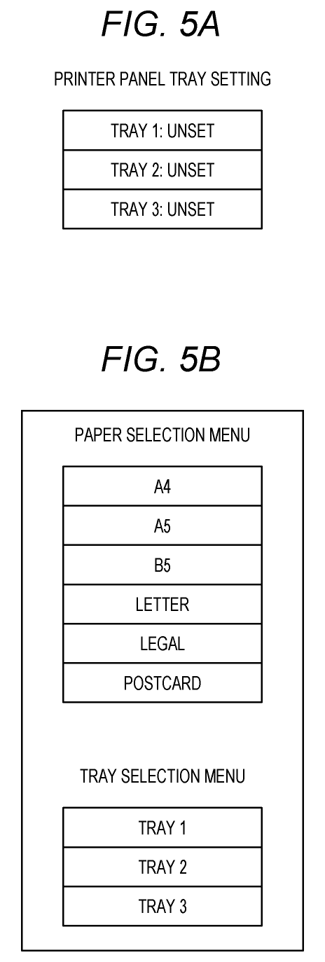

In the example illustrated in FIG. 5A, the printer 200 includes three paper trays including the tray 1, the tray 2, and the tray 3, and a size of a printing sheet stored in each tray is not set for any of the tray 1, the tray 2, and the tray 3. In this case, there is a possibility that any of the printing sheets having a size that can be stored in each of the tray 1, the tray 2, and the tray 3 may set. In this example, each of the tray 1, the tray 2, and the tray 3 can store all paper sizes of A4, A5, B5, Letter, Legal, and Postcard. Therefore, as illustrated in FIG. 5B, all paper sizes of A4, A5, B5, Letter, Legal, and Postcard are displayed in the paper selection menu of the application 102. The tray 1, the tray 2, and the tray 3, which are not set, are displayed in the tray selection menu. Accordingly, in a case where the user executes printing, the user can select a corresponding paper size in the paper selection menu and select a paper tray suitable for the selected paper size in the tray selection menu, thereby executing printing matching the user's intention. In this case, it is necessary that the printing sheet of the size to be printed by the user is set in advance or to be set in any one of the trays 1, 2, and 3.

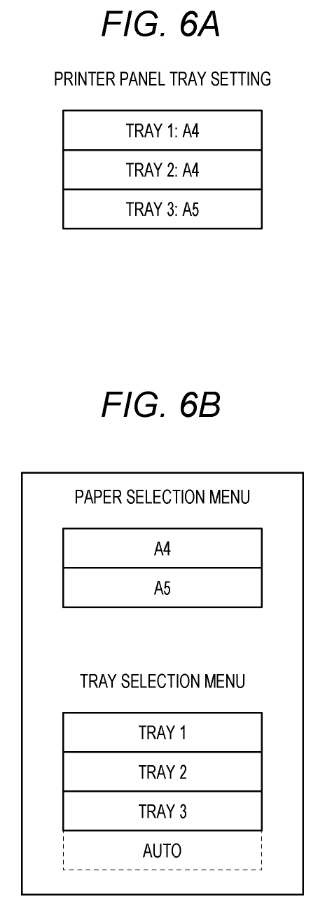

In the example illustrated in FIG. 6A, the printer 200 includes three paper trays including the tray 1, the tray 2, and the tray 3, and a size of a printing sheet stored in each tray is set to A4 for the tray 1, A4 for the tray 2, and A5 for the tray 3. In this example, the tray 1 and the tray 2 have the same paper size, but one of the tray 1 and the tray 2 is set with a general sheet of A4, and the other is set with a special sheet of A4. Examples of the special sheet include a sheet on which predetermined characters, patterns, and the like are printed in advance, a sheet colored in a predetermined color, and a sheet made of a special material. In this case, if "Auto" is set in the tray selection menu, there is a possibility that printing is executed on a printing sheet different from the printing sheet intended by the user. Therefore, as illustrated in FIG. 6B, paper sizes of A4 and A5 are displayed in the paper selection menu of the application 102, and the tray 1, the tray 2, and the tray 3 are displayed in the tray selection menu. Accordingly, when the user executes printing on a general sheet or a special sheet of A4, the user can select a size of A4 in the paper selection menu and select a paper tray in which a corresponding A4 sheet is stored in the tray selection menu, thereby executing printing matching the user's intention. The same applies to a case where printing is executed on an A5 sheet.

For example, when a priority order can be set between the tray 1 and the tray 2, "Auto" may be displayed in addition to the tray 1, the tray 2, and the tray 3 in the tray selection menu as indicated by a dotted line in FIG. 6B. For example, among the tray 1 and the tray 2 in which A4 is set, the priority order may be set higher than that in which a special sheet is stored when a general sheet is stored, and the higher priority order may be selected in "Auto". In this case, when the user executes printing on a general sheet of A4 or A5, the user selects a corresponding paper size in the paper selection menu and selects "Auto" in the tray selection menu, so that printing matching the user's intention can be executed. In addition, when the user executes printing on a special sheet of A4, the user can select a size of A4 in the paper selection menu and select a paper tray in which a corresponding A4 sheet is stored in the tray selection menu, thereby executing printing matching the user's intention.

Further, in this case, by selecting the paper selection menu A4 and the tray selection menu Auto in a case where the same type of sheet is in the tray 1 and the tray 2, it is possible to print the sheet of the tray 2 as it is without additionally setting the menu when the sheet of the tray 1 runs out.

### Control Procedure

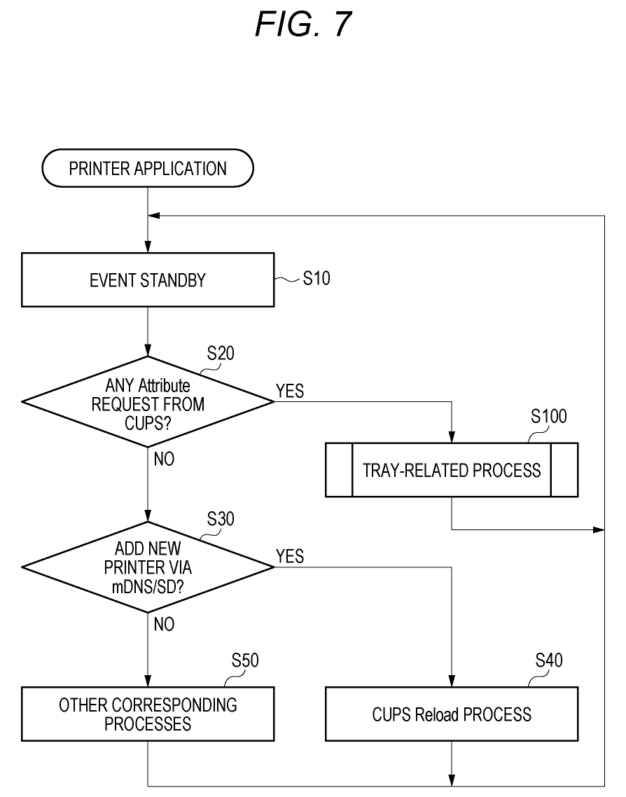

A control procedure executed by the printer application 170 to realize the display of the paper selection menu and the tray selection menu described above will be described with reference to flowcharts of FIGS. 7 to 9.

As illustrated in FIG. 7, in step S10, the printer application 170 waits until an event occurs.

In step S20, the printer application 170 determines whether there is an attribute request related to the paper tray and the printing sheet from the CUPS 160. When there is an attribute request (step S20: Yes), the printer application 170 advances the process to the next step S100.

In step S100, the printer application 170 executes a tray-related process. Details of the tray-related process will be described later. Thereafter, the process returns to step S10.

On the other hand, in step S20, when there is no attribute request (step S20: No), the printer application 170 advances the process to the next step S30.

In step S30, the printer application 170 determines whether a new printer 200 is added using a multicast Domain Name System/Service Discovery (mDNS/SD) protocol. When a new printer 200 is added (step S30: Yes), the printer application 170 advances the process to the next step S40.

In step S40, the printer application 170 executes a reload process of notifying the CUPS 160 of the added printer 200 by the mDNS/SD protocol. The CUPS 160 registers a virtual printer corresponding to the printer 200 generated by the printer application 170. Data necessary for the registration is provided by the mDNS/SD. Thereafter, the process returns to step S10.

On the other hand, in step S30, when no new printer 200 is added (step S30: No), the printer application 170 advances the process to the next step S50.

In step S50, the printer application 170 executes processes corresponding to other events. Thereafter, the process returns to step S10. Thus, this flowchart ends.

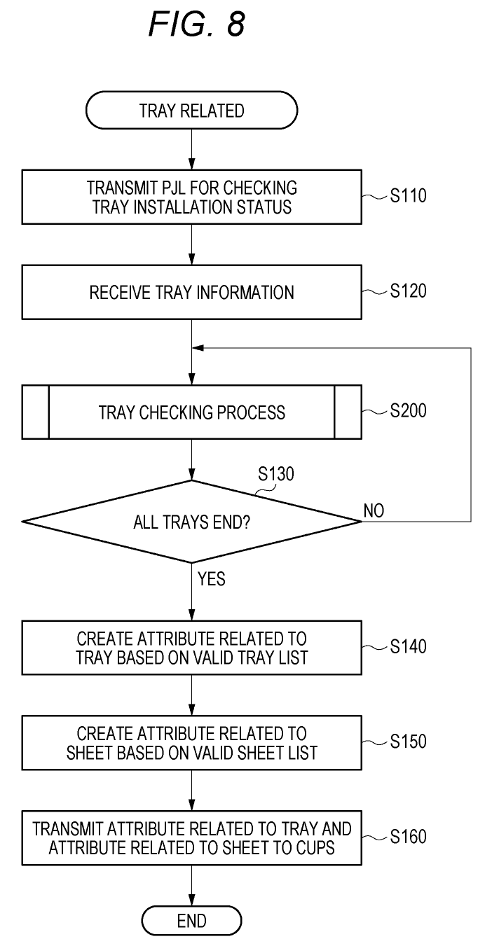

FIG. 8 illustrates an example of a control procedure executed in the tray-related process in step S100.

As illustrated in FIG. 8, in step S110, the printer application 170 transmits printer job language (PJL) for checking a tray installation status to the printer 200 which is a request target of the requested attribute request. The PJL for checking the tray installation status is a command for requesting transmission of tray information related to a paper tray provided in the printer 200. The tray information includes, for example, the number of paper trays provided in the printer 200 and tray identification information for identifying the paper tray. The tray identification information is, for example, a tray number or a tray ID.

In step S120, the printer application 170 receives the tray information transmitted from the printer 200 according to the PJL for checking the tray installation status. The tray information is an example of sheet feed environment information, and step S120 is an example of an environment information acquisition process.

In step S200, the printer application 170 executes a tray checking process for checking a paper tray included in the printer 200. In a case where the printer 200 includes a plurality of paper trays, the tray checking process is repeatedly executed for each paper tray. Details of the tray checking process will be described later.

In step S130, the printer application 170 determines whether the tray checking process in step S200 has been ended for all the paper trays included in the printer 200. When the tray checking process has not been ended for all the paper trays (step S130: No), the printer application 170 shifts a processing target to the next paper tray and repeats step S200. On the other hand, when the tray checking process has been ended for all the paper trays (step S130: Yes), the printer application 170 advances the process to the next step S140.

In step S140, the printer application 170 generates an attribute related to the paper tray based on a valid tray list generated in the tray checking process in step S200. In other words, according to tray sheet setting information acquired in step S220 to be described later, an attribute related to a paper tray suitable for the sheet feed environment of the printer 200 is generated. The generated attribute related to the paper tray is an example of tray capability information corresponding to the valid tray list and an example of valid capability information suitable for the sheet feed environment of the printer 200, and step S140 is an example of a capability information generation process.

In step S150, the printer application 170 generates an attribute related to the printing sheet, based on the valid sheet list generated in the tray checking process in step S200. In other words, according to the tray sheet setting information acquired in step S220 described later, an attribute related to the printing sheet suitable for the sheet feed environment of the printer 200 is generated. The generated attribute related to the printing sheet is an example of the sheet capability information corresponding to the valid sheet list and an example of the valid capability information suitable for the sheet feed environment of the printer 200, and step S150 is an example of a capability information generation process.

In step S160, the printer application 170 transmits the attribute generated in step S140 and related to the paper tray and the attribute generated in step S150 and related to the printing sheet to the CUPS 160. Step S160 is an example of a capability information output process. Thus, this flowchart ends.

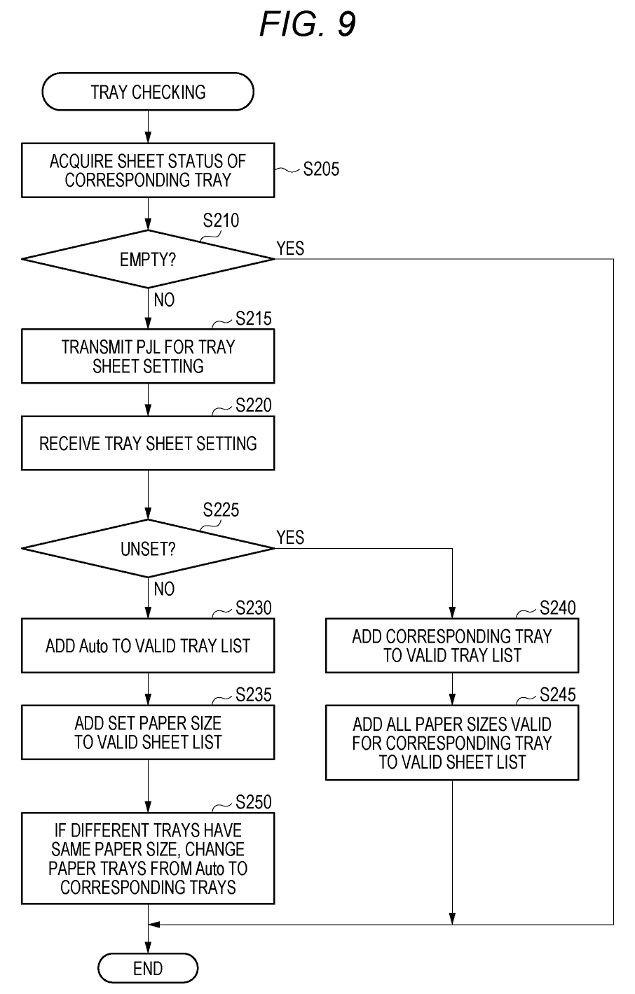

FIG. 9 illustrates an example of a control procedure executed in the tray checking process in step S200.

As illustrated in FIG. 9, in step S205, the printer application 170 acquires sheet status information of a paper tray corresponding to a processing target. The sheet status information is the number of printing sheets stored in the corresponding paper tray, and is detected by, for example, a sensor provided in the paper tray. The sheet status information is an example of sheet feed environment information, and step S205 is an example of an environment information acquisition process.

In step S210, based on the sheet status information acquired in step S205, the printer application 170 determines whether the number of printing sheets in the paper tray is 0, that is, whether the paper tray is empty. The empty is an example of less than a predetermined value, and the predetermined value in this case is 1. The quantity is an example of a storage amount, and step S210 is an example of a storage amount determination process. The predetermined value may be set to 2 or more, and it may be determined whether the number of printing sheets is less than the predetermined value. When the printer application 170 determines that the paper tray is empty (step S210: Yes), the printer application 170 ends the process without changing the valid tray list and the valid sheet list. That is, when the printer application 170 determines in step S210 that the paper tray is empty, the printer application 170 does not add the paper tray to the valid tray list. As a result, the paper tray is not included in the attribute related to the paper tray created in step S140, and the paper tray is not displayed in the tray selection menu.

On the other hand, in step S210, when the printer application 170 determines that the paper tray is not empty (step S210: No), the process proceeds to the next step S215.

In step S215, the printer application 170 transmits, to the printer 200, a PJL for requesting tray sheet setting information related to the printing sheet stored in the paper tray corresponding to the processing target. The tray sheet setting information includes, for example, paper size information associated with the tray identification information of a corresponding paper tray and capable of identifying a size of a printing sheet set for the paper tray. The paper size information is set for each tray via the operation unit such as a printer panel. The paper size information may be, for example, paper size information capable of identifying a size of the printing sheet actually stored in the corresponding paper tray. In this case, the paper size information may be information of a size of the printing sheet detected by, for example, a sensor provided in the paper tray.

In step S220, the printer application 170 receives the tray sheet setting information transmitted from the printer 200, according to the PJL for requesting the tray sheet setting information. The tray sheet setting information is an example of sheet feed environment information, and step S220 is an example of an environment information acquisition process.

In step S225, the printer application 170 determines whether the tray sheet setting information received in step S220 is unset information corresponding to unsetting in which the size of the printing sheet is not identified. When the tray sheet setting information is not unset information (step S225: No), the printer application 170 advances the process to the next step S230.

In step S230, the printer application 170 adds "Auto" to the valid tray list. "Auto" in the valid tray list represents an automatic selection setting for automatically selecting any one of the plurality of paper trays. That is, in step S230, based on the tray sheet setting information acquired in step S220, a valid tray list representing any one automatic selection setting of a plurality of pieces of tray identification information is created. Step S230 is an example of a valid tray list creation process.

In step S235, the printer application 170 adds a paper size set for the paper tray corresponding to the processing target to the valid sheet list, based on the tray sheet setting information received in step S220. That is, in step S235, based on the tray sheet setting information received in step S220, a valid sheet list including the size of the printing sheet corresponding to the paper tray associated with the tray identification information is created. Step S235 is an example of a valid sheet list creation process.

In step S250, in a case where different paper trays have the same paper size, the printer application 170 changes paper trays from "Auto" to the tray identification information of the corresponding trays. That is, in step S250, in a case where "Auto" is included in the valid tray list in step S230, it is determined whether the printing sheets stored in the plurality of paper trays have a common size based on the tray sheet setting information acquired in step S220. When the printing sheets stored in the plurality of paper trays have a common size, "Auto" is changed to the manual selection setting for the corresponding tray identification information. Step S250 is an example of a valid tray list changing process. Thus, this flowchart ends.

On the other hand, in step S225, when the tray sheet setting information is unset information (step S225: Yes), the printer application 170 advances the process to the next step S240.

In step S240, the printer application 170 adds tray identification information of the paper tray to the valid tray list. The tray identification information in the valid tray list represents a manual selection setting for the user to manually select a paper tray corresponding to the tray identification information. That is, in step S240, based on the tray sheet setting information acquired in step S220, a valid tray list indicating a manual selection setting to any one of the plurality of pieces of tray identification information corresponding to the plurality of paper trays provided in the printer 200 is created. Step S240 is an example of a valid tray list creation process.

In step S245, the printer application 170 adds all paper sizes valid for the paper tray corresponding to the processing target to the valid sheet list. That is, in step S245, based on the tray sheet setting information received in step S220, a valid sheet list including all sizes of the printing sheets that can be stored in the corresponding paper tray is created. Step S245 is an example of a valid sheet list creation process. Thereafter, the process ends.

When the priority order is set among the plurality of paper trays as described above, the tray identification information of both paper trays corresponding to "Auto" may be added in step S250.

### Effects of Embodiment

In the present embodiment, step S120, step S205, and step S220 are executed by the printer application 170. In step S120, step S205, and step S220, tray information, sheet status information, and tray sheet setting information that are related to the paper tray provided in the printer 200 and the printing sheets stored in the paper tray are acquired. In accordance with the acquired tray information, sheet status information, and tray sheet setting information, in steps S140 and S150, an attribute (valid capability information) suitable for the sheet feed environment of the printer 200 is generated. Accordingly, the generated attribute can be matched with the size of the printing sheet actually stored in the paper tray provided in the printer 200. As a result, it is possible to prevent a paper size selected and set by the user from being erroneously set not to match a paper size that can actually be printed by the printer 200. As a result, it is possible to prevent the user from being unintentionally forced to replace the sheet or to make extra settings.

Further, in particular, in the present embodiment, the tray information includes tray identification information for identifying the paper tray provided in the printer 200, and the tray sheet setting information includes paper size information capable of identifying a size of the printing sheet stored or set in the paper tray associated with the tray identification information. By the combination of the tray identification information and the paper size information, it is possible to clarify in which paper tray the printing sheets of which size are stored or set in association with each other.

Further, in particular, in the present embodiment, the printer application 170 executes step S230 and step S240 of creating a valid tray list representing at least one of a manual selection setting for any one of the plurality of paper trays provided in the printer 200 and an automatic selection setting for any one of the plurality of paper trays, based on the tray sheet setting information acquired in step S220. The attribute generated in step S140 includes an attribute related to the paper tray corresponding to the valid tray list created in steps S230 and S240.

Based on the generated valid tray list, for example, in the application 102, a list of paper trays excluding a paper tray that cannot correspond to one paper size selected by the user among the paper trays provided in the printer 200 can be displayed in a list. Alternatively, for the selection of the one paper size, the paper size can be automatically selected from the paper trays provided in the printer 200. Further, since the generated attribute includes the attribute corresponding to the valid tray list, the attribute based on the paper tray provided in the printer 200 and the paper size of the printing sheet associated with the paper tray can be reliably transmitted to the CUPS 160.

In the present embodiment, in particular, the printer application 170 executes step S235 and step S245 of creating a valid sheet list including all sizes of the printing sheets that can be stored in the paper tray when the tray sheet setting information acquired in step S220 includes unset information that does not identify the size of the printing sheet, and creating a valid sheet list including the size of the printing sheet corresponding to the paper tray associated with the tray identification information when the paper size information does not include unset information. The attribute generated in step S150 includes an attribute related to the printing sheet corresponding to the valid sheet list created in steps S235 and S245.

Based on the created valid sheet list, for example, in the application 102, paper sizes stored in or associated with the paper trays provided in the printer 200 can be displayed as a list in a manual selectable paper size. Alternatively, when the paper tray provided in the printer 200 is in a size unset state in which the size of the printing sheet is not identified, it is also possible to clearly indicate this state. Further, since the generated attribute includes the attribute related to the printing sheet, the attribute based on the paper tray provided in the printer 200 and the paper size of the printing sheet associated with the paper tray can be reliably transmitted to the CUPS 160.

In the present embodiment, in particular, the printer application 170 executes step S210 of determining whether the number of printing sheets in the paper tray is empty based on the sheet status information acquired in step S205. When a paper tray is determined to be empty, an attribute related to the paper tray generated in step S140 does not include the paper tray. In other words, the printer application 170 is configured not to generate an attribute related to a paper tray determined to be empty. Accordingly, when there is an empty paper tray in the printer 200, the paper tray or the printing sheet corresponding to the paper tray can be prevented from being selected by the user. In addition, the attribute may not include the paper tray when the number of remaining sheets is smaller than a predetermined number instead of empty. In this case, it is possible to avoid the inconvenience that printing using the printing sheet having a small number of remaining sheets is executed and the sheet runs out during the execution.

Further, in particular, in the present embodiment, in a case where "Auto" is included in the valid tray list created in step S230 and step S240, and in the tray sheet setting information acquired in step S220, when the printing sheets stored in the plurality of paper trays have a common size, the printer application 170 executes step S250 of changing "Auto" to the corresponding tray identification information.

In a case where the paper size stored in at least one paper tray is known or the paper size is associated with at least one paper tray, the paper tray can be automatically selected according to the paper size selected by the user by including "Auto" in the valid tray list. However, in a case where sheets of the same size are stored in or associated with the plurality of paper trays, it is not determined which of the plurality of paper trays is to be used, and thus the automatic selection is impossible. Therefore, in the present embodiment, in such a case, by executing step S250, "Auto" is exceptionally canceled, and the setting is changed to the manual selection setting of the paper tray by the user. Accordingly, the above-described inconvenience can be avoided.

### Modification

The present disclosure is not limited to the above-described embodiment, and various modifications are possible without departing from the gist and technical idea of the above-described embodiment.

(1) When the fact that the paper tray is empty is displayed in the tray selection menu, in the above embodiment, the empty paper tray is not displayed in the tray selection menu by not including the paper tray in the attribute when the paper tray is empty, but the present disclosure is not limited thereto. For example, the fact that the paper tray is empty may be displayed on the tray selection menu.

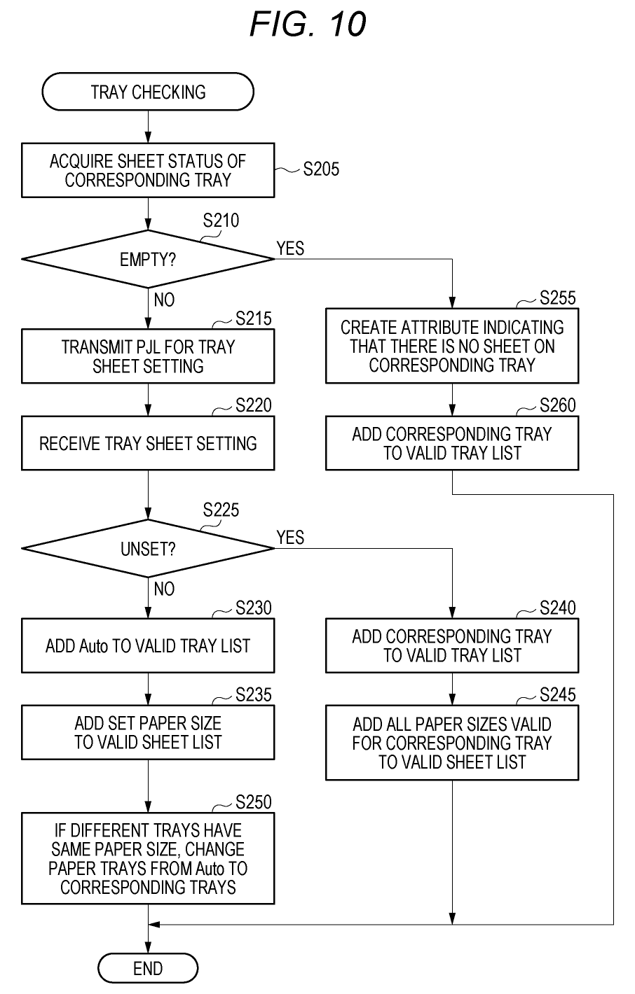

FIG. 10 illustrates an example of a control procedure executed in a tray checking process in the present modification. FIG. 10 is different from FIG. 9 described above in that step S255 and step S260 are added, and other steps are the same as those in FIG. 9, and thus the description thereof will be appropriately omitted.

As illustrated in FIG. 10, in step S210, when the printer application 170 determines that the paper tray is empty (step S210: Yes), the printer application 170 advances the process to the next step S255.

In step S255, the printer application 170 creates an attribute indicating that there is no printing sheet on the paper tray corresponding to the processing target. The attribute includes information for identifying the paper tray and information indicating that the storage amount of the printing sheet is empty in the identified paper tray. The attribute is an example of valid capability information, the information for identifying the paper tray is an example of specific tray capability information, and the information indicating empty is an example of specific sheet capability information. Step S255 is an example of a capability information generation process.

In step S260, the printer application 170 adds an empty paper tray to the valid tray list. Thereafter, the process proceeds to step S250. Since steps other than the above are the same as those in FIG. 9, description thereof will be omitted.

Thereafter, in step S140 described above, the attribute related to the paper tray is generated to include the empty paper tray based on the valid tray list. Then, in step S160, the attribute generated in step S140 and related to the paper tray and the attribute generated in step S150 and related to the printing sheet are transmitted to the CUPS 160 together with an attribute generated in step S255 and indicating that there is no printing sheet in the paper tray.

According to the modification example described above, when the printing sheet in the paper tray provided in the printer 200 is empty, it is possible to notify the user of the fact. When the number of remaining sheets is smaller than a predetermined number instead of empty, the user may be notified of the fact. In this case, it is possible to cause the user to recognize in advance that there is a possibility that the printing using the printing sheet having a small number of remaining sheets is executed and the sheet runs out during the execution.

(2) Others

The user may be allowed to select a case where all paper sizes available in the printer 200 are displayed as in the above-described comparative example and a case where paper sizes actually set or stored in the printer 200 are displayed as in the above-described embodiment.

Although the printer application 170 updates the valid tray list and the valid sheet list in the tray checking process when there is an attribute request from the CUPS 160 in the present exemplary embodiment, the printer application 170 may periodically (for example, every five seconds) execute the tray checking process, and may reflect the change in the valid tray list and the valid sheet list by reloading the CUPS 160 when there is a change in the sheet and the tray. Further, at that time, the printer 200 may be periodically inquired about only whether there is a change in relation between the tray and the sheet by a method with a relatively small communication load (for example, control transfer of USB), and only when the change is notified from the printer 200, the inquiry about information on the sheet and the tray and a change process of the valid sheet list and the valid tray list may be executed.

Further, since tray installation information is not usually dynamically changed, steps S110 and S120 can be omitted by diverting the response at the time of the previous inquiry.

In the above-described embodiment, the tray sheet setting information is the paper size information set for the paper tray, but the present invention is not limited thereto. The tray sheet setting information may be, for example, paper type information indicating a type of a printing sheet such as plain paper, recycled paper, thick paper, or an envelope. In this case, an attribute (valid capability information) may be created by adding the type of the printing sheet to the valid sheet list, and the paper type may be displayed in the paper selection menu.

The flowcharts illustrated in FIGS. 7 to 10 do not limit the present invention to the procedures illustrated in the above flow, and addition, deletion, change in the order, and the like of the procedures may be made without departing from the gist and the technical idea of the invention.

In addition to the above, the methods according to the embodiment and the modifications may be appropriately combined and used.

In addition, although not illustrated, the present invention may be carried out with various modifications within a scope not departing from the gist thereof.

### Hardware Configuration of Terminal Device and Printer

An example of a hardware configuration of the terminal device 100 and the printer 200 will be described with reference to FIG. 11.

### Terminal Device

As illustrated in FIG. 11, the terminal device 100 includes the processor 110, the storage device 115, the display unit 140, an operation unit 150, and a communication interface 190. The processor 110, the storage device 115, the display unit 140, the operation unit 150, and the communication interface 190 are connected to each other via a bus 105 to be able to transmit and receive data.

The storage device 115 includes a volatile storage device 120 and the nonvolatile storage device 130. The volatile storage device 120 is, for example, a DRAM, and stores various programs and data to be processed. The nonvolatile storage device 130 is, for example, a hard disk drive or a solid-state drive, and includes a program storage region 131 and the data storage region 132.

Various programs are stored in the program storage region 131. The various programs include the printer application 170, the printing processing programs, and the like described above based on the flowcharts of FIGS. 7 to 10 described above. The data storage region 132 stores data and the like necessary for executing various programs.

The processor 110 is a device configured to execute data processing, for example, a CPU, and executes various programs stored in the program storage region 131. The processor 110 is configured to execute various processes including data communication with the printer 200 connected to a network NT. The processor 110 and the programs stored in the program storage region 131 are examples of a calculation unit and a controller.

The display unit 140 is, for example, a liquid crystal display, and may be configured to display various kinds of information. The operation unit 150 is, for example, a keyboard or a button, and configured to receive an input operation by the user. The user may operate the operation unit 150 to input various instructions to the terminal device 100.

The communication interface 190 is an interface for communicating with other devices, and is connected to the network NT. The communication interface 190 is an example of a communication I/F.

The storage device 115 is not limited to the configuration of the above-described device elements, and may be implemented by, for example, a RAM, a ROM, an EEPROM, an HDD, a portable recording medium such as a USB memory attached to and detached from the terminal device 100, a buffer included in the processor 110, or a combination thereof.

The storage device 115 may be a computer-readable storage medium. The computer-readable storage medium is a non-transitory medium. The non-transitory medium also includes a recording medium such as a CD-ROM or a DVD-ROM, in addition to the above-described examples. The non-transitory medium is also a tangible medium. The same applies to a storage device 215 of the printer 200 to be described later.

### Printer

As illustrated in FIG. 11, the printer 200 includes a processor 210, a storage device 215, a display unit 240, an operation unit 250, a communication interface 270, and a printing unit 290. The processor 210, the storage device 215, the display unit 240, the operation unit 250, the communication interface 270, and the printing unit 290 are connected to each other via a bus 205 to be able to transmit and receive data.

The storage device 215 includes a volatile storage device 220 and a nonvolatile storage device 230. The volatile storage device 220 is, for example, a DRAM, and includes an image data storage region 222 that stores image data to be printed. The nonvolatile storage device 230 is, for example, an NVRAM, and a flash memory, and includes a program storage region 231 and a data storage region 232. Various programs are stored in the program storage region 231. The various programs include firmware such as printing processing programs. The data storage region 232 stores various data and the like for executing the various programs.

The processor 210 is a device configured to execute data processing, and is, for example, a processor such as a CPU. The processor 210 is configured to execute various programs stored in the program storage region 231.

The display unit 240 is, for example, a liquid crystal display, and may be configured to display various kinds of information. The operation unit 250 is a device configured to receive an operation by the user. The user may operate the operation unit 250 to input various instructions to the printer 200. The communication interface 270 is a wired or wireless network interface for communicating with other devices, and is connected to the network NT.

The printing unit 290 is configured to print an image on a printing sheet conveyed by a conveying mechanism (not illustrated). The printing unit 290 is configured to print an image on the printing sheet, based on print data transmitted from the terminal device 100 or a print job generated by the printing unit 290 based on an operation on the operation unit 250.

What is claimed is:

1. A non-transitory computer readable storage medium storing an information processing program executable by a processor of an information processing device, the information processing program being configured to execute print control using a printing device configured to communicate with the information processing device,
the printing device being configured to execute printing on a printing sheet stored in a paper tray,
the information processing device being loaded with an operating system having printing software for executing printing in response to an instruction from an application, and
the information processing program being configured to be registered in the printing software as a virtual printing device,
wherein the information processing program is configured to, when executed by the processor, cause, on a condition that the information processing program is registered in the printing software as the virtual printing device, a controller of the information processing device to execute:
an environment information acquisition process of acquiring sheet feed environment information related to the paper tray provided in the printing device and to the printing sheet stored in the paper tray;
a capability information generation process of generating valid capability information according to the sheet feed environment information acquired in the environment information acquisition process;
a capability information output process of outputting, to the printing software in which the information processing program is registered as the virtual printing device, the valid capability information generated in the capability information generation process;
a print data acquisition process of acquiring, from the printing software in which the information processing program is registered as the virtual printing device, first print data corresponding to the valid capability information output in the capability information output process; and
a print data transmission process of transmitting, to the printing device, second print data based on the first print data acquired in the print data acquisition process.

2. The non-transitory computer readable storage medium according to claim 1,
wherein the sheet feed environment information includes:
tray identification information for identifying the paper tray provided in the printing device; and
paper size information for identifying a size of the printing sheet stored or set in the paper tray associated with the tray identification information.

3. The non-transitory computer readable storage medium according to claim 2,
wherein the information processing program is further configured to, when executed by the processor, cause, on the condition that the information processing program is registered in the printing software as the virtual printing device, the controller of the information processing device to execute:
a valid tray list creation process of creating, based on the sheet feed environment information acquired in the environment information acquisition process, a valid tray list representing at least one of: a manual selection setting for any one of a plurality of pieces of tray identification information; and an automatic selection setting for any one of the plurality of pieces of tray identification information, the plurality of pieces of tray identification information corresponding to each of a plurality of paper trays provided in the printing device, and
the valid capability information includes:
tray capability information corresponding to the valid tray list created in the valid tray list creation process.

4. The non-transitory computer readable storage medium according to claim 2,
wherein the information processing program is further configured to, when executed by the processor, cause, on the condition that the information processing program is registered in the printing software as the virtual printing device, the controller of the information processing device to execute:
a valid sheet list creation process of creating a valid sheet list, based on the sheet feed environment information acquired in the environment information acquisition process, the valid sheet list including:
in a case where unset information that does not identify a size of the printing sheet is included in the paper size information, all sizes of the printing sheets capable of being stored in the paper tray; and
in a case where the unset information is not included in the paper size information, all sizes of the printing sheets corresponding to the paper tray associated with the tray identification information, and
the valid capability information includes:
sheet capability information corresponding to the valid sheet list created in the valid sheet list creation process.

5. The non-transitory computer readable storage medium according to claim 1,
wherein the information processing program is further configured to, when executed by the processor, cause, on the condition that the information processing program is registered in the printing software as the virtual printing device, the controller of the information processing device to execute:
a storage amount determination process of determining whether a storage amount of the printing sheets in any of the paper trays is less than a predetermined value, based on the sheet feed environment information acquired in the environment information acquisition process, and
in a case where it is determined in the storage amount determination process that the storage amount of the printing sheets is less than the predetermined value, the valid capability information is not generated in the capability information generation process.

6. The non-transitory computer readable storage medium according to claim 1,
wherein the information processing program is further configured to, when executed by the processor, cause, on the condition that the information processing program is registered in the printing software as the virtual printing device, the controller of the information processing device to execute:
a storage amount determination process of determining whether a storage amount of the printing sheets stored in any one of the paper trays is less than a predetermined value, based on the sheet feed environment information acquired in the environment information acquisition process, and
in a case where it is determined in the storage amount determination process that the storage amount is less than the predetermined value, the valid capability information generated in the capability information generation process includes specific tray capability information identifying the paper tray and specific sheet capability information indicating that the storage amount is less than the predetermined value in the identified paper tray.

7. The non-transitory computer readable storage medium according to claim 3,
wherein the information processing program is further configured to, when executed by the processor, cause, on the condition that the information processing program is registered in the printing software as the virtual printing device, the controller of the information processing device to execute:
a valid tray list changing process of changing the automatic selection setting to the manual selection setting for the corresponding tray identification information, in a case where the automatic selection setting is included in the valid tray list created in the valid tray list creation process and the printing sheets stored in the plurality of paper trays have a common size in the sheet feed environment information acquired in the environment information acquisition process.

8. An information processing device comprising:
a communication I/F configured to communicate with a printing device; and
a controller including an operating system having printing software, and an information processing program,
the printing device being configured to execute printing on a printing sheet stored in a paper tray, and
the information processing program being registered in the printing software as a virtual printing device,
wherein the controller is configured to execute:
an environment information acquisition process of acquiring sheet feed environment information related to the paper tray provided in the printing device and to the printing sheet stored in the paper tray;
a capability information generation process of generating valid capability information according to the sheet feed environment information acquired in the environment information acquisition process;
a capability information output process of outputting, to the printing software in which the information processing program is registered as the virtual printing device, the valid capability information generated in the capability information generation process;
a print data acquisition process of acquiring, from the printing software in which the information processing program is registered as the virtual printing device, first print data corresponding to the valid capability information output in the capability information output process; and
a print data transmission process of transmitting, to the printing device, second print data based on the first print data acquired in the print data acquisition process.
